(19) United States
(12) Patent Application Publication
(10) Pub. No.: US 2018/0356569 A1
(43) Pub. Date: Dec. 13, 2018

(54) REFLECTING PRISM FOR OPTICAL RESONANT CAVITY, AND OPTICAL RESONANT CAVITY AND SPECTRAL MEASUREMENT INSTRUMENT THEREOF

(71) Applicant: SUZHOU TAOSPEC OPTRONICS CO., LTD., Suzhou (CN)

(72) Inventors: Wenping Deng, Suzhou (CN); Hui Zhoa, Suzhou (CN)

(21) Appl. No.: 15/780,210

(22) PCT Filed: Nov. 25, 2016
(86) PCT No.: PCT/CN2016/107258

§ 371 Date: May 30, 2018

(30) Foreign Application Priority Data
Dec. 1, 2015 (CN) 201510862675.1

(51) Int. Cl. G02B 5/04; G01N 21/31; H01S 3/02; G01J 3/42

(52) U.S. Cl. CPC G02B 5/04; G01N 21/31; G01N 2021/0396; G01J 3/42; H01S 3/02

(57) ABSTRACT

The present application discloses a reflecting prism for an optical resonant cavity, an optical resonant cavity and a spectral measurement instrument. Said optical resonant cavity has a sample measurement region, and said reflecting prism comprises a first surface for receiving light rays passing through said sample measurement region, a second surface for emitting light rays to said sample measurement region, and a third surface between said first surface and said second surface, said third surface for totally reflecting the light rays received from said first surface to said second surface. The reflective prism for the optical resonant cavity, the optical resonant cavity and the spectral measurement instrument provided by the present application can be favorable to the miniaturization of the reflecting prism of the optical resonant cavity, and thus help reduce the material absorption loss of light rays.

### CROSS REFERENCE TO RELATED REFERENCES

This application claims the priority of Chinese Patent Application No. 201510862675.1, filed on Dec. 1, 2015, entitled “Reflecting prism for Optical Resonant Cavity, Optical Resonant Cavity and Spectral Measurement Instrument,” the entire content of which is incorporated herein by reference.

### BACKGROUND

### Technical Field

The present application relates to the field of spectroscopy, and in particular to a reflecting prism for an optical resonant cavity, an optical resonant cavity and a spectral measurement instrument.

### Description of the Related Art

The subject of spectroscopy studies spectra. In contrast with other subjects that focus on frequency, spectroscopy specializes in visible light and near-visible light—a very narrow part of the available spectrum which ranges in wavelength from about 1 mm to about 1 nm. Near visible light includes infrared rays and ultraviolet rays. This range extends far enough on both sides of the visible light band, but most lenses and reflectors made of common materials are still effective for this light band, and it must often be considered that the optical properties of the materials are dependent on the wavelength of light.

Absorption spectroscopy can detect or identify different molecular types, especially simple molecular types such as water. At the same time, a spectral measurement instrument provides high sensitivity, response time on the order of microseconds, anti-interference capability, and limited interference from molecular substances other than the substances being studied. Therefore, absorption spectroscopy is a general method for detecting important micro/trace substances. In the gas state, because the substances have their absorption strength concentrated in a set of sharp spectral lines, the sensitivity and selectivity of this technique are both optimized. This sharp spectral line in the spectrum can be used to discriminate most interfering substances.

In many production processes, it is extremely necessary to measure and analyze the concentration of trace substances in flowing gas streams with a high degree of speed and accuracy, because the concentration of contaminants is often critical to the quality of end products. For example, gases such as N2, O2, H2, Ar and He are used to manufacture integrated circuits. Impurities in these gases such as water even at parts per billion (ppb) levels are detrimental, and may reduce the yield of qualified integrated circuit products. Therefore, in the semiconductor industry that requires high-purity gases, higher sensitivity is very important to the manufacturer. Impurities such as water can be detected by means of high sensitivity of spectroscopy. In other industrial production processes, it is also necessary to detect a variety of impurities.

Spectroscopy can detect water at parts per million (ppm) levels in high-purity gases, and in some cases, can also obtain detection sensitivity of parts per billion (ppb) levels. Therefore, several spectroscopic methods have been known to monitor the content of water in a gas, including: traditional absorption measurement of long optical path cell elements, photoacoustic spectroscopy, frequency modulation spectroscopy, and intracavity laser absorption spectroscopy. However, as described by Lehmann in U.S. Pat. No. 5,528,040, these spectroscopic methods have a plurality of characteristics so that they are impractical and difficult to be used in industrial applications. Therefore, they are largely limited only to laboratory research.

However, CRDS (cavity ring-down spectroscopy) has become an important spectroscopic technique which is applied to scientific research, industrial production control, and atmospheric micro/trace gas monitoring. It has been proven that CRDS, as a light absorption measurement technique, is superior to conventional methods in which sensitivity is not very ideal in a state of low absorbance. CRDS takes an average photon lifetime in a high-precision optical resonant cavity as an appreciable measure of absorption sensitivity.

In general, an optical resonant cavity is formed by a pair of nominally identical, narrowband, and ultra-highly reflective dielectric reflectors that are suitably configured to form a stable optical resonant cavity. A laser pulse is incident into the optical resonant cavity through one reflector to experience an average lifetime, which depends on the photon transit time, the length of the optical resonant cavity, the absorption cross section and the amount of concentration of the substances, and the internal loss factor of the optical resonant cavity (mainly due to the frequency-dependent reflectivity of the reflectors when the diffraction loss is negligible). Therefore, the determination of light absorption is converted from a conventional power ratio measurement to a time decay measurement. Ultimate sensitivity of CRDS is determined by the amount of loss inside the optical resonant cavity, and loss can be minimized by using an ultra-low-loss optical device such as those produced with fine polishing techniques.

Due to the fact that it is not yet possible to produce reflectors with sufficiently high reflectivity, the application of CRDS has limitations in the field of spectroscopy using dielectric reflectors with high reflectivity, which greatly limits the method in the application of most infrared and ultraviolet rays. Even in the field of dielectric reflectors with appropriate reflectivity, each set of reflectors can only be effective over a small wavelength range, typically over only a few percent of the wavelength range. Moreover, manufacturing of many dielectric reflectors requires use of some materials that may degrade over time, especially when being exposed to chemically corrosive environments. These limitations restrict or prevent the use of CRDS in many potential applications.

In order to solve the above problem, an optical resonant cavity is described in the Chinese Patent No. CN1397006A, entitled “Mode matching for cavity ring-down spectroscopy based upon Brewster's angle prism retroreflectors.” The optical resonant cavity includes a first Brewster's angle reflecting prism having a set of total reflection surfaces with one of the total reflection surfaces being a curved surface, a second Brewster's angle reflecting prism having a set of total reflection surfaces and being disposed in alignment with the first prism along the optic axis of the resonant cavity, and an optical element for coupling radiation into one of the first and second prisms.

However, the optical path of the above optical resonant cavity in use is a double-optical-path closed loop, and the incident surface in the reflecting prism of the optical resonant cavity also serves as an exit surface. In order to prevent the optical paths from overlapping, the geometry of the reflecting prism of the optical resonant cavity is limited thereto. Thus, it is difficult to miniaturize the device, which may result in larger absorption loss of light induced by the reflecting prism when the light passes through the reflecting prism, affecting the measurement sensitivity of the entire spectrometer.

### BRIEF SUMMARY

In view of the deficiencies of the prior art, the present application provides a reflecting prism for an optical resonant cavity, an optical resonant cavity, and a spectral measurement instrument, which can be favorable to the miniaturization of the reflecting prism of the optical resonant cavity, and thus help reduce the material absorption loss of light rays.

To achieve the above object, the present application provides a reflecting prism for an optical resonant cavity, said optical resonant cavity having a sample measurement region, and said reflecting prism comprising a first surface for receiving light rays passing through said sample measurement region, a second surface for emitting light rays to said sample measurement region, and a third surface between said first surface and said second surface, and said third surface for totally reflecting said light rays received from said first surface to said second surface.

As a preferred embodiment, said first surface and said second surface are Brewster's surfaces, and said third surface is a total internal reflection surface.

As a preferred embodiment, at least one surface of said reflecting prism is a curved surface.

To achieve the above object, the present application further provides an optical resonant cavity capable of receiving and emitting light rays and capable of transmitting the received light rays internally, said optical resonant cavity comprising:

an optical element, said optical element comprising at least one of any of reflecting prisms as described above; and

a sample measurement region capable of containing a sample to be measured.

As a preferred embodiment, said optical element is capable of forming a closed optical path.

As a preferred embodiment, the number of said optical elements is at least three.

As a preferred embodiment, each of said optical elements is said reflecting prism.

As a preferred embodiment, said reflecting prism comprises a first reflecting prism, a second reflecting prism and a third reflecting prism; a second surface of said first reflecting prism is connected with a first surface of said second reflecting prism through a first optical path, a second surface of said third reflecting prism is connected with a first surface of said first reflecting prism through a second optical path, and a second surface of said second reflecting prism is connected with a first surface of said third reflecting prism through a third optical path; an included angle between said first optical path and said second optical path, an included angle between said second optical path and said third optical path, and an included angle between said third optical paths and said first optical path are all greater than

$$2 ( {asin}^{- 1} ( 1 / n ) + {asin}^{- 1} ( \frac{1}{n} ( sin ( {θ}_{B} ) ) ) - {θ}_{B} ) ,$$

wherein θ_{B} is a Brewster's angle.

As a preferred embodiment, in each of said reflecting prisms, an included angle between said third surface and said second surface is equal to an included angle between said third surface and said first surface, and is equal to the sum of 0.5 time of the included angle between said first optical path and said second optical path and θ_{B}.

As a preferred embodiment, said optical resonant cavity further comprises: a matching optical element capable of matching an optical mode of a light source with an optical mode of said optical resonant cavity.

As a preferred embodiment, at least one of said optical elements is capable of being rotated and/or translated.

To achieve the above object, the present application further provides a spectral measurement instrument, comprising: the optical resonant cavity described in any one of the above embodiments.

As can be seen from the above description, said reflective prim for said optical resonant cavity provided by the present application is provided with said first surface for receiving light rays in said optical resonant cavity and said second surface for emitting light rays in said optical resonant cavity, and said first surface and said second surface are different surfaces independent of each other, which can ensure that only a single spot remains on the surfaces of said reflecting prism, resulting in the requirement to be met as long as the side length of said reflecting prism is greater than the size of said single spot. Therefore, said reflective prim for said optical resonant cavity provided by the present application can be favorable to the miniaturization of the reflecting prism of the optical resonant cavity, and thus help reduce the material absorption loss of light rays.

### BRIEF DESCRIPTION OF THE SEVERAL VIEWS OF THE DRAWINGS

In order to more clearly illustrate the technical solutions in the embodiments of the present invention or the prior art, the accompanying drawings needed to be used in describing the embodiments or the prior art are briefly described. Apparently, the accompanying drawings in the following description are only some embodiments of the present invention, and from these drawings, other drawings can be obtained by an ordinary person skilled in the art without any creative effort.

FIG. 1 is a schematic diagram of a Gaussian beam propagating along the Z axis;

FIG. 2 is a schematic diagram of a Gaussian beam with a complex parameter q;

FIG. 3 is a schematic diagram of a two-reflector optical resonant cavity composed of two reflectors;

FIG. 4 is a schematic diagram of a folded cavity in an optical resonant cavity;

FIG. 5 is a schematic diagram of an equivalent multi-element straight cavity of the folded cavity shown in FIG. 4;

FIG. 6 is a schematic diagram of a loop cavity in an optical resonant cavity;

FIG. 7 is a schematic diagram of an equivalent multi-element straight cavity of the loop cavity shown in FIG. 6;

FIG. 8 is a schematic diagram of a parallel plane cavity;

FIG. 9 is a schematic diagram of non-polarized incident light rays incident on a glass surface from the air;

FIG. 10 is a schematic diagram of a reflecting prism provided by an embodiment of the present application;

FIG. 11 is a schematic diagram of a reflecting prism with a curved surface provided by an embodiment of the present application;

FIG. 12 is a schematic diagram of a reflecting prism with a curved surface provided by another embodiment of the present application;

FIG. 13 is a schematic diagram of an optical resonant cavity provided by an embodiment of the present application;

FIG. 14 is a schematic diagram of an optical resonant cavity provided by an embodiment of the present application;

FIG. 15 is a schematic diagram of an optical resonant cavity provided by an embodiment of the present application;

FIG. 16 is a schematic diagram of an optical resonant cavity provided by an embodiment of the present application;

FIG. 17 is a schematic diagram of an optical resonant cavity provided by an embodiment of the present application;

FIG. 18 is a schematic diagram of a lens provided on an optical path of an optical element provided by an embodiment of the present application;

FIG. 19 is a schematic diagram of an optical element provided with a reflector provided by an embodiment of the present application;

FIG. 20 is a module schematic diagram of a spectral measurement instrument provided by an embodiment of the present application.

### DETAILED DESCRIPTION

In order to enable those skilled in the art to better understand the technical solutions in the present application, the technical solutions in the embodiments of the present application will be clearly and completely described below with reference to the accompanying drawings in the embodiments of the present application. Obviously, the described embodiments are merely a part of the embodiments of the present application and not all of the embodiments. All other embodiments obtained by an ordinary person skilled in the art based on the embodiments of the present application without any creative efforts shall fall within the protection scope of the present invention.

### I. General Principle

A general introduction to the general principles of optics related to the present invention will be given below. The general introduction will provide background information for completely understanding the present invention.

A: Gaussian Beam

A Gaussian beam is a special solution of the Helmholtz equation under an approximation of slow vibration, and can describe the properties of a fundamental mode laser beam well. A schematic diagram of propagation of the Gaussian beam along the z-axis is given in FIG. 1.

The law of propagation of the Gaussian beam in space is given in Equation (1.1).

$$E ( r , z ) = \frac{{A}_{0} {ω}_{0}}{ω ( z )} exp [ - \frac{{r}^{2}}{{ω}^{2} ( z )} ] exp \{ - i \{ k [ \frac{{r}^{2}}{2 R ( z )} + z ] - Ψ \} \} \qquad ( 1.1 )$$

where, R(z), ω(z) and Ψ are expressed as below:

ω(z)=ω₀\sqrt{1+(z/z₀)²} (1.2)

R(z)=Z₀(z/Z₀+Z₀/z) (1.3)

Ψ=tan⁻¹(z/Z₀) (1.4)

Equation (1.2) shows the beam width of the Gaussian beam, Equation (1.3) shows the curvature radius of the isophase plane of the Gaussian beam, and Equation (1.4) shows the phase factor of the Gaussian beam, where

$${Z}_{0} = \frac{{πω}_{0}^{2}}{λ} .$$

The Gaussian beam can be determined by any two of R(z), ω(z) and z. The Gaussian beam is generally represented by a complex parameter q, as shown in Equation (1.5).

$$\frac{1}{q ( z )} = \frac{1}{R ( z )} - i \frac{λ}{{πω}^{2} ( z )} \qquad ( 1.5 )$$

The transformation of the complex parameter q of the Gaussian beam through an optical system of a transformation matrix

$$M = ( \begin{matrix}A & B \\ C & D\end{matrix} )$$

follows the ABCD law:

$${q}_{2} = \frac{{Aq}_{1} + B}{{Cq}_{1} + D} \qquad ( 1.6 )$$

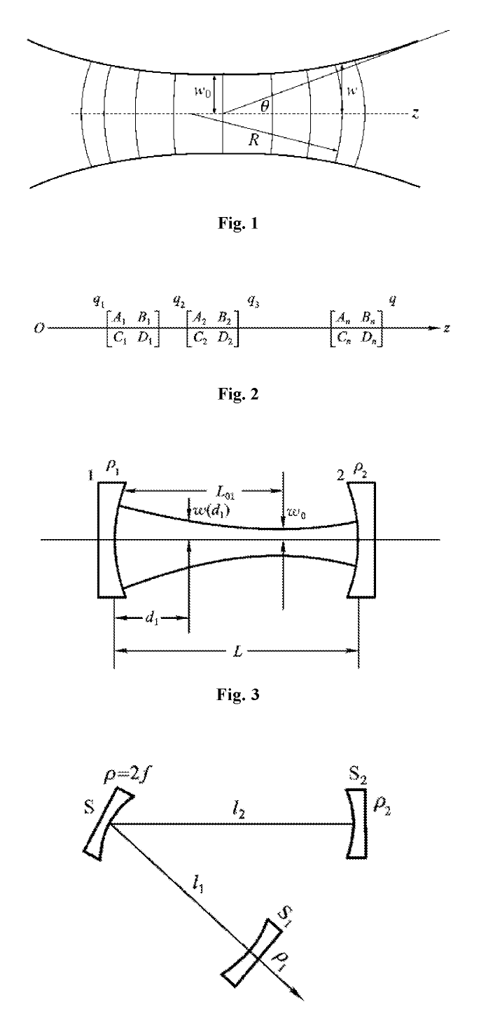

As shown in FIG. 2, if a Gaussian beam with a complex parameter q₁ becomes a Gaussian beam with a complex parameter q by sequentially passing through an optical system of a transformation matrix given by:

$${M}_{1} = ( \begin{matrix}{A}_{1} & {B}_{1} \\ {C}_{1} & {D}_{1}\end{matrix} ) , {M}_{2} = ( \begin{matrix}{A}_{2} & {B}_{2} \\ {C}_{2} & {D}_{2}\end{matrix} ) , … , {M}_{n} = ( \begin{matrix}{A}_{n} & {B}_{n} \\ {C}_{n} & {D}_{n}\end{matrix} ) , \qquad ( 1.7 )$$

at this time, the ABCD law also holds, but ABCD are elements of the following matrix M:

M=MₙLM₂M₁ (1.8)

B: Optical Resonant Cavity

A stable optical resonant cavity refers to cause the complex parameter q of the Gaussian beam to satisfy a self-reproducing condition after one cycle of propagation (one round trip or one full round trip), i.e., q=q (T) or there being a Gaussian distribution in the cavity. Therefore, the optical resonant cavity has two characteristics: 1) the size of the resonant cavity is much larger than the wavelength of the light wave; and 2) the resonant cavity is generally an open cavity.

A calculation method for calculating the stability condition of a common optical resonant cavity according to the ABCD law is given below. It should be noted that the ABCD law is not a unique calculation method, for example, an analytical method can also be used to calculate it.

1. Simple Two-Reflector Resonant Cavity

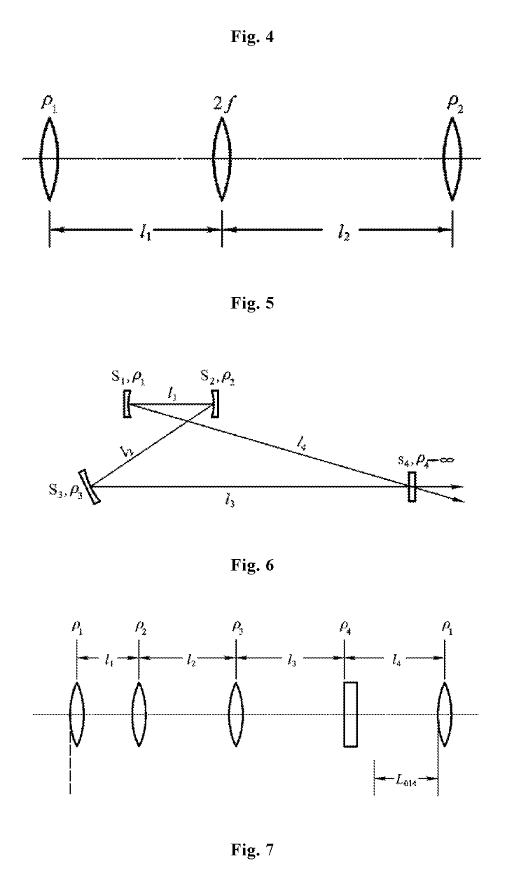

FIG. 3 shows a resonant cavity consisting of two reflectors. Gaussian beams present in a stable cavity can only be self-reproducing, that is, the Gaussian beams are required to be equal to itself after a round-trip transmission within the cavity.

As shown in FIG. 3, with reference to reflector 1, the round-trip matrix is as

$$M = ( \begin{matrix}A & B \\ C & D\end{matrix} ) = ( \begin{matrix}1 & 0 \\ - \frac{2}{{ρ}_{1}} & 1\end{matrix} ) ( \begin{matrix}1 & L \\ 0 & 1\end{matrix} ) ( \begin{matrix}1 & 0 \\ - \frac{2}{{ρ}_{2}} & 1\end{matrix} ) ( \begin{matrix}1 & L \\ 0 & 1\end{matrix} ) = ( \begin{matrix}4 {g}_{1} {g}_{2} - 1 - 2 {g}_{2} & 2 {Lg}_{2} \\ \frac{2}{L} ( 2 {g}_{1} {g}_{2} - {g}_{1} - {g}_{2} ) & 2 {g}_{2} - 1\end{matrix} ) , \qquad ( 1.9 )$$

where

$${g}_{i} = 1 - \frac{L}{{ρ}_{i}} , i = 1 , 2.$$

Let q₁ be the complex parameter of an initial Gaussian beam on reflector 1, and after a round-trip transmission, the complex parameter is q, and the self-reproducing condition of the stable cavity requires q=q1.

From the ABCD law,

$${q}_{1} = \frac{{Aq}_{1} + B}{{Cq}_{1} + D} , \qquad ( 1.10 )$$

we will obtain:

$$\frac{1}{{q}_{1}} = \frac{D - A}{2 B} \pm i \frac{\sqrt{4 - {( A + D )}^{2}}}{2 B} . \qquad ( 1.11 )$$

In combination with equation (1.5), the ± sign in Equation (1.11) should be selected so that

$$\pm \frac{\sqrt{4 - {( A + D )}^{2}}}{2 B}$$

is ensured to be negative, that is, the square of the beam width is ensured to be positive.
where

$$\frac{1}{{q}_{1}} = \frac{1}{{R}_{1}} - i \frac{λ}{{πω}_{1}^{2}} \qquad ( 1.12 )$$

By substituting Equations (1.9) and (1.12) into Equation (1.11), we will obtain:

$$\begin{matrix}{ω}_{1}^{2} = {\frac{λ L}{π} [ \frac{{g}_{2}}{{g}_{1} ( 1 - {g}_{1} {g}_{2} )} ]}^{\frac{1}{2}} , & ( 1.13 ) \\ {R}_{1} = {ρ}_{1} . & ( 1.14 )\end{matrix}$$

In order to hold Equation (1.13) to be positive, Equation (1.15) must be satisfied:

0<g₁g₂<1 (1.15)

Here, Equation (1.15) is the stability condition for the simple two-reflector cavity.

2. Folded Cavity

As shown in FIG. 4, when a reflector is used to fold the optical path, a folded cavity is formed. The folded cavity can be unfolded into a multi-element straight cavity for analysis. For example, with reference to reflector S1, the three-reflector folded cavity shown in FIG. 4 can be unfolded into a thin lens sequence shown in FIG. 5. In this way, the method used in the calculation for the two-reflector resonant cavity as described above can be used to calculate the stability condition of the folded cavity, except for the differences in the elements of the ABCD matrix.

3. Loop Cavity

As shown in FIG. 6, a cavity where a beam is transmitted along a polygonal closed optical path in the cavity is referred to as a loop cavity. Under the Gaussian beam approximation, the parameter q of the beam that can exist in a stable loop cavity should satisfy the self-reproducing condition for one full round trip. In the calculation, a surrounding matrix should be used for the loop cavity.

Taking reflectors 1, 2, 3, and 4 as reference planes, respectively, the loop cavity is unfolded into a periodic thin lens sequence. With reference to reflector i, the surrounding matrix is

$$M = ( \begin{matrix}A & B \\ C & D\end{matrix} ) .$$

Then, the stability condition is |A+D|<2; the beam width of the fundamental mode Gaussian beam at reflector i is

$${ω}_{i}^{2} = \pm \frac{2 λ B / π}{\sqrt{4 - {( A + D )}^{2}}} ;$$

the curvature radius of the isophase plane of the Gaussian beam at reflector i is

$${R}_{i} = \frac{2 B}{D - A} ;$$

the beam waist width at a divided arm of the beam is

$${ω}_{0 ij}^{2} = \pm \frac{λ}{2 π C} \sqrt{4 - {( A + D )}^{2}} ;$$

and with reference to reflector i, the beam waist position is

$${L}_{0 ij} = \frac{A - D}{2 C} .$$

For example, with reference to reflector S1, an equivalent periodic thin lens sequence of a traveling wave (set along the direction of reflectors S1→S2→S3→S4→S1) is as shown in FIG. 7, thereby obtaining the surrounding matrix (1.16):

$$M = ( \begin{matrix}A & B \\ C & D\end{matrix} ) = ( \begin{matrix}1 & {l}_{3} + {l}_{4} \\ 0 & 1\end{matrix} ) ( \begin{matrix}1 & 0 \\ - \frac{2}{{ρ}_{3}} & 1\end{matrix} ) ( \begin{matrix}1 & {l}_{2} \\ 0 & 1\end{matrix} ) ( \begin{matrix}1 & 0 \\ - \frac{2}{{ρ}_{2}} & 1\end{matrix} ) ( \begin{matrix}1 & {l}_{1} \\ 0 & 1\end{matrix} ) = ( \begin{matrix}1 & 0 \\ - \frac{2}{{ρ}_{1}} & 1\end{matrix} ) . \qquad ( 1.16 )$$

From this, the stability condition of the loop cavity and the relevant parameters of the Gaussian beam can be obtained.

C: Modes of Laser, Mode Matching, and Resonance Condition

Modes of laser are defined as possible eigenstates of the electromagnetic field in an optical resonant cavity. Different modes correspond to different field distributions and resonant frequencies. The modes can be divided into longitudinal modes and transverse modes. A stable field distribution in the longitudinal direction of the cavity, which is characterized by an integer n, is generally called a longitudinal mode. At the same time, there is also a stable field distribution in a plane perpendicular to the propagation direction of the electromagnetic field, which is a transverse mode. Different transverse modes correspond to different laterally stable light field distributions and different frequencies.

Mode matching means that the mode of a light beam and the mode of an optical resonant cavity must satisfy a matching condition, that is, the waist spot radius and position of the light beam coupled into the optical resonant cavity should completely coincide with the waist spot radius and position of the optical resonant cavity.

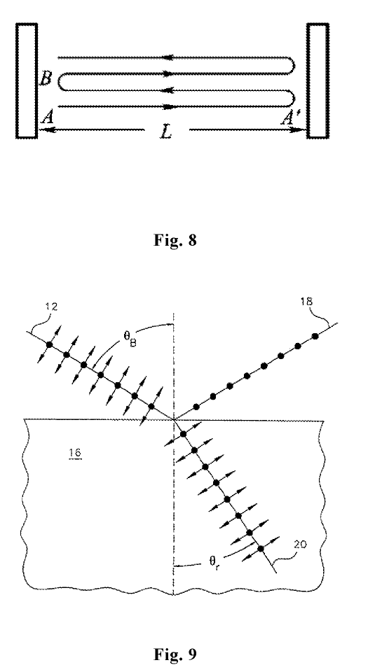

Resonance condition: Taking a parallel plane cavity shown in FIG. 8 as an example, in order to be able to form a stable oscillation in a cavity, it is required that light waves should be strengthened by interference. The condition of interference is that the phase difference of a light wave before and after undergoing a round trip along the axis in the cavity is an integral multiple of 2π: Δφ=2πm. From the relationship between the optical path length difference and the phase difference, we will obtain Δφ=2L(2π/λ_{q})=2πq. Then, we will have L=q(λ_{q}/2) (standing wave condition of the optical cavity). The frequency is expressed as ν_{q}=(c/2L)q, which is called the resonance condition, with ν_{q} being the resonance frequency.

D: Total Reflection

Total reflection: When a light ray is directed from a first medium to a second medium having a larger optical density than the first medium, the light ray will be refracted toward a normal direction. When a light ray is directed from an optically thicker medium to an optically thinner medium, the light ray will be refracted away from the normal direction. There is an angle called a critical angle β, so that light rays with incident angles greater than the critical angle are all reflected without refraction. This effect is called total internal reflection, and this effect occurs inside the material of one medium having a higher optical density than that outside of the interface.

E: Brewster's Law

Brewster's Law: FIG. 9 depicts a non-polarized incident light ray 12 being incident on a glass surface 16 from the air. The refractive index n of glass is generally 1.5. The electric field vector of each wave train in the light ray can be decomposed into two components: one component perpendicular to the plane of incidence in the figure and the other component in the plane of incidence. The first component, denoted by black dots here, is the S-polarized component (derived from the German word “senkrecht,” meaning vertical); the second component, denoted by the arrow, is the P (parallel)-polarized component. On average, for completely non-polarized light, the amplitudes of the two components are equal.

For glass or other dielectric materials, there is a special angle of incidence, called the polarization angle (found by David Brewster in experiments, hence also called a Brewster's angle), which has a reflection coefficient of 0 for the P-polarized component. Therefore, the light ray 18 reflected from the glass surface belongs to plane-polarized light, of which the vibration plane is perpendicular to the first surface, although its light intensity is low. The P-polarized component at the polarization angle is totally refracted at an angle of θᵣ, whereas the S-polarized component is only partially refracted. It can be seen from FIG. 9 that the light ray 20 is partially-polarized light.

F: Reflecting Prism

A prism is a device of a refractive and reflective type. An optical component having one or more third surfaces on the same glass is called a reflecting prism, such as common right angle prisms, isosceles prisms, corner cube prisms, cube prisms and the like.

### II. Reflecting Prism for Optical Resonant Cavity, Optical Resonant Cavity, and Spectral Measurement Instrument of the Present Application

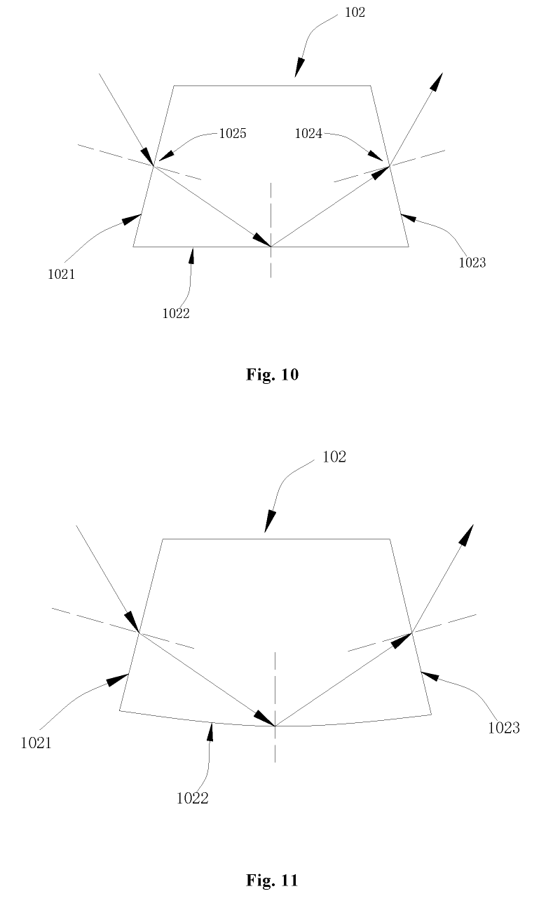

Referring to FIG. 10, a reflecting prism 102 for an optical resonant cavity is provided by an embodiment of the present application. The reflecting prism 102 is used to form the optical resonant cavity 100. The optical resonant cavity 100 has a measurement region 103. The reflecting prism 102 has a first surface 1021 for receiving light rays passing through the measurement region 103, a second surface 1023 for emitting light rays to the measurement region 103, and a third surface 1022 between the first surface 1021 and the second surface 1023, the third surface 1022 for totally reflecting the light rays received from the first surface 1021 to the second surface 1023.

The reflecting prism 102 may form the optical resonant cavity 100. Specifically, the reflecting prism 102 is used to form a closed optical path 101 in the optical resonant cavity 100. In the process of measuring a sample, a light ray emitted by a light source is incident into the optical resonant cavity, and the light ray partially exits after being propagated in the optical resonant cavity for one round, which can be defined as a primary exit event. The light ray corresponding to the exit light propagates again for one round and then partially exits again, which can be defined as a secondary exit event. If the exiting positions and directions of the exit light rays for the primary exit event and the secondary exit event nominally coincide with each other completely, it indicates that light rays satisfying such an incident condition have formed the closed optical path 101 in the resonant cavity.

FIG. 13 can be taken as an example. In FIG. 13, incident light (P-polarized light) emitted from the outside is incident on the second surface 1023 of a first reflecting prism P at a near Brewster's angle. The light rays reflected from the second surface 1023 are incident on the second reflecting prism 102 at a Brewster's angle, and exit at Brewster's angle after being totally reflected inside the second reflecting prism M. The transmitted light propagates in the third reflecting prism 102 in the same manner. The light ray 101 transmitted from the third reflecting prism N is incident on the first surface 1021 of the first reflecting prism P at near a Brewster's angle. The first surface 1021 reflects a part of the light rays and transmits another part thereof. This is a signal of the primary exit event. The partially transmitted light rays continue to propagate inside the reflecting prisms 102 and between the reflecting prisms until it is again incident from the third reflecting prism N to the first surface 1021 of the first reflecting prism P at a near Brewster's angle. Similarly, the first surface 1021 reflects a part of the light rays, and transmits another part thereof. This is a signal of the secondary exit event. By analogy, if the signals for the secondary exit and primary exit events have the same position and direction on the first surface 1021, then it indicates that light rays satisfying the incident condition have formed a closed optical path in the resonant cavity. Without considering absorption loss of the medium, Fresnel loss, scattering loss, diffraction loss, etc., theoretically light rays can repeatedly circulate for an infinite number of times. In practice, due to the existence of various losses, the number of circulations is limited. Meanwhile, it can also be seen in FIG. 13 that the light rays encircling the closed optical path 101 include the light rays passing through the measurement region 103 and the light rays propagating inside the reflecting prisms 102.

The reflecting prisms 102 may be disposed on the boundary of the measurement region 103 for containing a sample to be measured, so as to ensure that light rays emitted from the reflecting prism 102 can pass through the sample to be measured and be absorbed by it. P-polarized light may be used as the light rays. In the measurement operation, when the light rays propagate to the reflecting prism 102 in the closed optical path 101, the first surface 1021 receives the light rays from other optical elements in the closed optical path 101 and then refracts and transmits the light rays to the third surface 1022 of the present reflecting prism 102, to complete the incident operation. Then, the third surface 1022 reflects the light rays to the second surface 1023 of the present reflecting prism to complete the reflection operation. The second surface 1023 receives the light rays from the third surface 1022 and then refracts and transmits the light rays to other optical elements in the closed optical path 101. When there are multiple reflecting prisms 102, each of the reflecting prisms 102 sequentially completes the incident operation, the reflection operation, and the exit operation until the light rays can form a stable closed optical path 101.

It can be seen from the above description that the reflecting prism 102 for the optical resonant cavity provided by the present embodiment is provided with the first surface 1021 for receiving light rays in the closed optical path 101 and the second surface 1023 for emitting light rays in the closed optical path 101, and the first surface 1021 and the second surface 1023 are different surfaces independent of each other, which can ensure that only a single spot remains on the surfaces of the reflecting prism 102, resulting in the requirements to be met as long as the side length of the reflecting prism 102 is greater than the size of the single spot. Therefore, the reflective prim 102 for the optical resonant cavity provided by the present application can be favorable to the miniaturization of the reflecting prism 102 of the optical resonant cavity 100, and thus help reduce the material absorption loss of light rays.

In the present embodiment, the reflecting prism 102 is used to form the closed optical path 101. The closed optical path 101 is formed by multiple reflections and refractions of light rays between optical elements in the optical resonant cavity 100. Light rays located in the closed optical path 101 can be absorbed by the sample to be measured when passing through the sample to be measured. The optical elements forming the closed optical path 101 may have various combinations. Specifically, for example, the optical elements may include the reflecting prism 102 and other kinds of reflecting prisms 102; or the optical elements may also include a reflector and the reflecting prism 102, or the optical elements may only include a plurality of reflecting prisms 102. The present application is not limited thereto. It should be noted that the reflecting prism 102 is only a part of the optical elements forming the closed optical path 101. That is, the reflecting prism 102 provided by the present embodiment may be one of the optical elements forming the closed optical path 101, or may also be more of the optical elements forming the closed optical path 101. Of course, when the number of the reflecting prisms 102 is three or more, all of the reflecting prisms 102 can make the light rays form the closed optical path 101.

The reflecting prism 102 may be a triangular prism with a triangular cross section as a whole. To facilitate the miniaturization of the device and assembly with other optical elements, the reflecting prism 102 may also be a frustum (truncated pyramid) with a trapezoidal cross section as a whole. Each of the reflecting prisms 102 has three surfaces independent of each other, i.e., the first surface 1021, the third surface 1022, and the second surface 1023. The first surface 1021 and the second surface 1023 may be oppositely disposed, and the third surface 1022 may be located between the first surface 1021 and the second surface 1023.

Of course, a single reflecting prism 102 may also be an irregularly shaped prism, and a plurality of surfaces thereof may function as a single first surface 1021, a single second surface 1023, and a single third surface 1022. This can also be an embodiment of the present application. It should be noted that when the number of the reflecting prisms 102 is more than one, the shapes of the reflecting prisms 102 may be the same or different, as long as each of the reflecting prisms 102 may combine with other reflecting prisms 102 to make the light rays form a closed optical path 101. The present application is not limited thereto.

Referring to FIG. 13, the reflecting prisms 102 are located at the boundary of the measurement region 103 in the optical resonant cavity 100. The measurement region 103 may be provided with a sample to be measured. The measurement region includes at least a region through which the light rays in the closed optical path pass, which ensures that the light rays effectively pass through the sample to be measured. The sample to be measured may be a solid, a gas, or a liquid, or may also be a liquid crystal or a biological tissue. When the reflecting prisms 102 are positioned at the boundary of the measurement region 103, the reflecting prisms 102 will have a surface being in contact with the sample to be measured. Specifically, for example, since the light rays need to enter the first surface 1021 after passing through the sample to be measured, the first surface 1021 needs to be in direct contact with the sample to be measured. Similarly, the second surface 1023 needs to be in contact with the sample to be measured. When the reflecting prism 102 is a frustum with a trapezoidal cross section, the reflecting prism 102 has one surface not involved in the optical action, and the surface is also placed in the sample to be measured.

In this embodiment, the material for manufacturing the reflecting prism 102 may be glass, and currently known and applicable materials include fused silica, sapphire, calcium fluoride, diamond, yttrium aluminum garnet (YAG), and silicon nitride (Si₃N₄), zirconium oxide (ZrO₂), alumina (Al₂O₃), hafnium dioxide (HfO₂) and the like. Of course, the material for manufacturing the reflecting prism 102 may also be other media that are transparent in the frequency range of light waves. The present application is not limited thereto. Since the kind of material described above is chemically inert, when a reflecting prism 102 made of the kind of material is positioned to perform measurement, the second surface 1023 and the first surface 1021 thereof are not damaged by a sample to be measured in the measurement region 103 and impurities contained in the sample to be measured. Alternatively, the second surface 1023 and the first surface 1021 may also be respectively attached with a material that is chemically inert to the sample to be measured and impurities in the sample to be measured.

In this embodiment, the first surface 1021 is used for receiving light rays in the closed optical path 101 and refracting them to the third surface 1022 of the present reflecting prism 102. When not participating in the operation of emitting light rays outside the closed optical path 101, in the reflecting prism 102, the incident angle of the light ray received by each of the first surfaces 1021 may be a Brewster's angle. In order to ensure transmittance of the first surface 1021, a high-transmittance film may be plated on the first surface 1021, which may further reduce the loss of light and at the same time reduce the occurrence of stray light. When participating in the operation of emitting light rays outside the closed optical path 101, the incident angle of the light ray received by the first surface 1021 needs to be a non-Brewster's angle, i.e., θ_{B}+δ, δ≠0. After the light rays are emitted from the first surface 1021, they can enter a detector. By analyzing the light rays, the physicochemical properties of the sample to be measured can be obtained. Preferably, the first surface 1021 may be a Brewster's surface, that is, the incident angle of the light ray incident on the first surface 1021 is a Brewster's angle or a near Brewster's angle. When the incident angle is a near Brewster's angle, δ is close to 0.

The second surface 1023 is used for receiving light rays from the third surface 1022 of the present reflecting prism 102 and refracting and emitting them to other optical elements in the closed optical path 101. When not participating in the operation of receiving light rays from outside the closed optical path 101, in the reflecting prism 102, the angle of the light ray received by each of the second surfaces 1023 after being refracted may be a Brewster's angle. In order to ensure transmittance of the second surface 1023, a high-transmittance film may be plated on the second surface 1023, which may further reduce the loss of light and at the same time reduce the occurrence of stray light. When participating in the operation of receiving light rays from the closed optical path 101, the incident angle of the light ray received by the second surface 1023 from the light source is a non-Brewster's angle, i.e., θ_{B}+δ, δ≠0. The optical path of the light ray received from the light source and then reflected from the second surface 1023 coincides with the optical path of the light ray received from the light source and then refracted by the second surface 1023. Preferably, the second surface 1023 may be a Brewster's surface, that is, the incident angle of the light ray incident on the second surface 1023 is a Brewster's angle or a near Brewster's angle. When the incident angle is a near Brewster's angle, δ is close to 0.

In the present embodiment, the third surface 1022 is used for receiving light rays from the first surface 1021 and totally reflecting the light rays to the second surface 1023. In order to reduce the loss of light during reflection, the third surface 1022 may be a total internal reflection surface. Preferably, the third surface 1022 can be plated with an internal reflection film to minimize the loss of light during propagation. Of course, the number of the third surfaces is not fixed, and may be one or may be more than one.

For example, as shown in FIG. 13, in the reflecting prism 102, the third surface 1022 may be far away from the measurement region, that is, away from the sample to be measured; and the second surface 1023, the first surface 1021, and the surfaces not involved in the optical action can be in direct contact with the sample to be measured. With this arrangement, the third surface 1022 is not affected by the sample to be measured and impurities in the sample to be measured. Thus, the environmental adaptability of the optical resonant cavity 100 provided by the present embodiment can be greatly improved.

In the present embodiment, preferably, at least one of the first surface 1021, the second surface 1023 and the third surface 1022 may be a curved surface. Preferably, at least one of the first surface 1021, the second surface 1023 and the third surface 1022 may be a curved surface. The curved surface can ensure that the closed optical path 101 formed by the light rays is more stable. In order to further correct astigmatism caused by the oblique incidence of light rays in the closed optical path 101, a condition for removing astigmatism needs to be satisfied between the curvature of the curved surface and the light rays. Certainly, as a preferred embodiment, it may also be based on FIG. 13 that at least one of the first surface 1021, the second surface 1023, and the third surface 1022 may be planar, or may not be a curved surface.

Specifically, as shown in FIG. 11, the curved surface may be formed by optically processing at least one of the first surface 1021, the second surface 1023, and the third surface 1022. Optical processing may include physical processing such as polishing, polishing on, and the like at least one of the first surface 1021, the second surface 1023, and the third surface 1022. The third surface 1022 can be processed into a curved surface by taking FIG. 11 as an example.

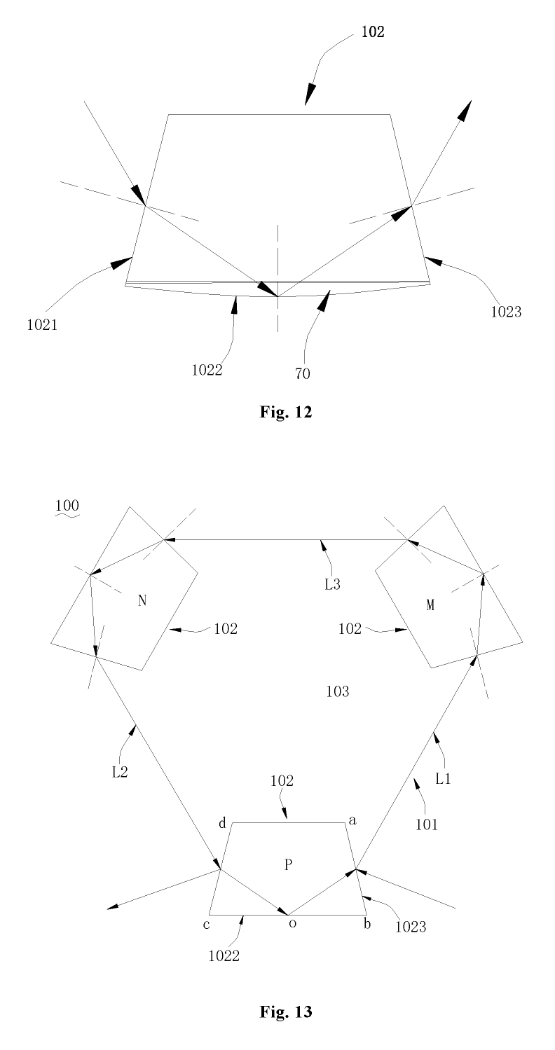

Further, as shown in FIG. 12, the curved surface may also be cemented by a lens 70 and at least one of the first surface 1021, the second surface 1023, and the third surface 1022 with an optical adhesive having a matching refractive index. The refractive index of the optical adhesive may be approximately equal to the refractive index of the curved surface. The refractive indices of the lens 70 and the reflecting prism 102 may be the same or different. The present application is not limited thereto.

In addition, the curved surface may be formed by optical contact of the lens 70 with at least one of the first surface, the second surface, and the third surface. The optical contact means smoothing one surface of the lens 70 and at least one of the first surface, the second surface and the third surface, pressing the two smoothed surfaces together, and then bonding the lens 70 with the reflecting prism 102 by attractive forces between molecules.

Continuing to refer to FIG. 10, in the present embodiment, the surfaces of the reflecting prism 102 may further have an emitting portion 1025 and a receiving portion 1024. The emitting portion 1025 is used for emitting light rays to the detector; and the receiving portion 1024 is used for receiving light rays from the light source. In this embodiment, the receiving portion 1024 can receive light rays from the light source to maintain the formation of the closed optical path 101. Specifically, for example, light rays are emitted from the light source and incident on the receiving portion 1024. The receiving portion 1024 is located on one surface of the reflecting prism 102, which may be a contact of the received light ray with the surface where it is located. The size of the receiving portion 1024 depends on the size of a spot formed by the received light ray on the surface where it is located. Of course, the size of the receiving portion 1024 should not be less than on the size of the spot formed by the received light ray on the surface where it is located.

The emitting portion 1025 can emit light rays to the detector, and the detector can obtain the physicochemical properties of the sample to be measured by receiving the light rays and performing calculation thereon. The emitting portion 1025 is located on one surface of the reflecting prism 102, which may be a contact of the emitted light ray with the surface on which it is located. The size of the emitting portion 1025 depends on the size of a spot formed by the emitted light ray on the surface where it is located. Of course, the size of the emitting portion 1025 should not be less than on the size of the spot formed by the emitted light ray on the surface where it is located.

It should be noted that the receiving portion 1024 and the emitting portion 1025 are two parts that do not overlap, which prevents the light source and the detector from overlapping. At the same time, in practical use, considering that the optical path is reversible, and the positions of the receiving portion 1024 and the emitting portion 1025 can be interchanged. In this case, the positions of the light source and the detector can be reversed. Of course, in the present embodiment, the receiving portion 1024 and the emitting portion 1025 may be located on different surfaces of the reflecting prism 102. Because the receiving portion 1024 and the emitting portion 1025 are located on different surfaces, the positions of the light source and the detector can be flexibly set, thereby facilitating the manufacture and assembly.

Further, the receiving portion 1024 may be located on the second surface 1023, and the emitting portion 1025 may be located on the first surface 1021. It can be seen that the second surface 1023 having the receiving portion 1024 can receive light rays from the light source and reflect the light rays, and can also receive light rays from the third surface 1022 and refract the light rays. The refraction position of the second surface 1023 having the receiving portion 1024 may coincide with the position of the receiving portion 1024, and further the optical path of the reflected light ray from the second surface 1023 coincides with the optical path of the refracted light ray, which facilitates the light to form the closed optical path 101. Similarly, the first surface 1021 having the emitting portion 1025 can receive light rays from other optical elements, and emit part of the light rays to the detector and at the same time refract another part of the light rays to the third surface 1022 to form a closed optical path 101.

Referring to FIG. 13, an embodiment of the present application further provides an optical resonant cavity 100 capable of receiving and emitting light rays and capable of transmitting the received light rays internally. The optical resonant cavity comprises: an optical element including at least one reflecting prism 102 as described in any one of the above embodiments; a receiving portion 1024 for receiving light rays from a light source; and an emitting portion 1025 for emitting light rays to the detector, wherein the receiving portion 1024 and the emitting The portion 1025 are located on the surfaces of the optical element.

The optical elements may be disposed on the boundary of the measurement region 103 for containing the sample to be measured, so as to ensure that light rays between two optical elements can pass through the sample to be measured and be absorbed by the sample to be measured. P-polarized light may be used as the incident light rays. When the measurement operation is performed, light rays are emitted from the light source, received by the receiving portion 1024 and entered the optical resonant cavity 100. When the light rays propagate to the reflecting prism 102 between the optical elements, the optical elements reflect the light rays to the first surface 1021 of the reflecting prism 102. The first surface 1021 refracts and transmits the light rays to the third surface 1022 of the present reflecting prism 102 to complete the incident operation. Then, the third surface 1022 reflects the light rays to the second surface 1023 of the present reflecting prism to complete the reflection operation. The second surface 1023 refracts and transmits the light rays to the first surface 1021 of the next reflecting prism 102 to complete the exit operation. Each of the optical elements sequentially completes the incident operation, the reflection operation, and the exit operation until the light rays form a stable closed optical path 101. When light rays propagate between the optical elements, the light rays are emitted from the emitting portion 1025 to a detector, i.e., emitting exit light rays. The detector receives the emitted light rays and calculates to obtain the composition of the sample to be measured.

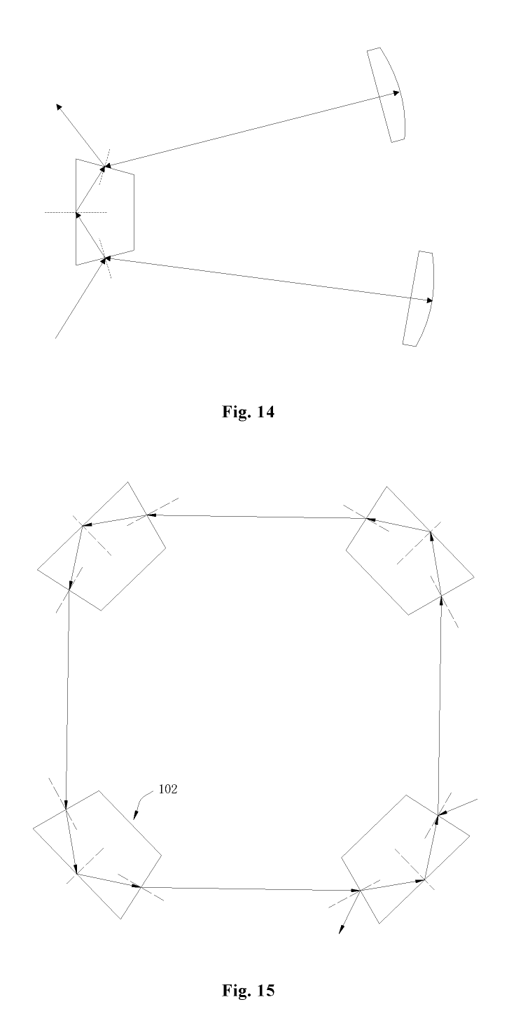

In this embodiment, the optical element can cause the light rays to form a closed optical path 101, and a preferred closed optical path is in a resonant state, thereby increasing the optical path length of light rays in the optical resonant cavity 100. In the closed optical path 101 in the resonant state, light rays can be reflected back and forth therein to provide stable light energy feedback. The number of the optical elements is more than one, and they are distributed at the boundary of the measurement region 103. The optical elements may only include the reflecting prism 102 to compose a prismatic optical resonant cavity 100. As shown in FIG. 14 and FIG. 17, the optical elements may include a reflector and the reflecting prism 102 to compose a hybrid optical resonant cavity 100. Alternatively, the optical elements may include other types of reflectors and the reflecting prism 102. The present application is not limited thereto, as long as the optical elements can ensure that the light rays form the closed optical path 101. Of course, in the present application, as a preferred embodiment, the optical element may only include the reflecting prism 102.

In the present embodiment, the optical element includes at least one reflecting prism 102. The number of the reflecting prisms 102 may not be limited. When there is a single reflecting prism 102, the reflecting prism 102 may cooperate with other kinds of reflecting prisms or reflectors to cause light rays to form a closed optical path 101. When there are a plurality of reflecting prism 102, light rays may be directed between the reflecting prisms 102 to form a closed optical path 101 without cooperating with other kinds of reflecting prisms 102 or reflectors. Of course, in a case where there are multiple reflecting prisms 102, they can still be used together with other kinds of reflecting prisms 102 or reflectors, and the present application is not limited thereto. In this embodiment, the receiving portion 1024 can receive light rays from the light source to maintain the formation of the closed optical path 101. Specifically, for example, light rays are emitted from the light source and incident on the receiving portion 1024. The receiving portion 1024 is located on one surface of the reflecting prism 102, which may be a contact of the received light ray with the surface where it is located. The size of the receiving portion 1024 depends on the size of a spot formed by the received light ray on the surface where it is located. Of course, the size of the receiving portion 1024 should not be less than on the size of the spot formed by the received light ray on the surface where it is located.

The emitting portion 1025 can emit light rays to the detector, and the detector can obtain the physicochemical properties of the sample to be measured by receiving the light rays and performing calculation thereon. The emitting portion 1025 is located on one surface of the reflecting prism 102, which may be a contact of the emitted light ray with the surface where it is located. The size of the emitting portion 1025 depends on the size of a spot formed by the emitted light ray on the surface where it is located. Of course, the size of the emitting portion 1025 should not be less than on the size of the spot formed by the emitted light ray on the surface where it is located.

The receiving portion 1024 and the emitting portion 1025 may be located on the same surface of the optical element, or may be located on different surfaces of the optical element. It should be noted that the receiving portion 1024 and the emitting portion 1025 are two parts that do not overlap, which prevents the light source and the detector from overlapping. Of course, in the present embodiment, the receiving portion 1024 and the emitting portion 1025 may be preferably located on both surfaces of the optical element. In the preferred solution, since the receiving portion 1024 and the emitting portion 1025 are located on different surfaces, the positions of the light source and the detector can be flexibly set, thereby facilitating the manufacture and assembly.

Further, the receiving portion 1024 may be disposed on one of the second surfaces 1023 in all the reflecting prisms 102, and the emitting portion 1025 may be disposed on one of the first surfaces 1021 of all the reflecting prisms 102. It can be seen that the second surface 1023 having the receiving portion 1024 can receive light rays from the light source and reflect the light rays, and can also receive light rays from the third surface 1022 of the present reflecting prism 102 and refract the light rays. The refraction position of the second surface 1023 having the receiving portion 1024 may coincide with the position of the receiving portion 1024, and further the optical path of the reflected light rays from the second surface 1023 coincides with the optical path of the refracted light rays, which facilitates the light rays to form the closed optical path 101. Similarly, the first surface 1021 having the emitting portion 1025 can receive light rays from other optical elements, and emit a part of the light rays to the detector and at the same time refract another part of the light rays to the third surface 1022 to form a closed optical path 101.

In the present embodiment, the number of the optical elements may be at least three, and each of the optical elements is the reflecting prism 102. The second surface 1023 having the receiving portion 1024 and the first surface 1021 having the emitting portion 1025 may be located on the same reflecting prism 102, or may be located on different reflecting prisms 102, so that the positions of the light source and the detector can be flexibly set. In the present embodiment, light rays pass through all of the reflecting prisms 102 to form a closed optical path 101. The reflecting prism 102 may be arranged in a non-straight line, and the third surface 1022 and the second surface 1023 in the same reflecting prism 102 are different planes. Moreover, the closed optical path formed by light rays in the reflecting prism 102 is a single closed optical path. It is ensured that one surface of each reflecting prism 102 only needs to undertake the incident operation or the exit operation, and there is only one incident spot or exit spot on the reflecting prism 102. As a result, the operational requirements may be met as long as the size of the surface is not smaller than the size of the incident spot or the exit spot.

It should be noted that, considering the high degree of integration of the optical elements, all of the reflecting prisms 102 can be integrally designed and molded, but if they still function as a plurality of the reflecting prisms 102, it still belongs to the solutions protected by the present application.

In this embodiment, the first surface 1021 is used for receiving light rays from the second surfaces 1023 of other optical elements and refracting it to the third surface 1022 of the present reflecting prism 102. Except for the first surface 1021 having the emitting portion 1025, in all the reflecting prisms 102, the incident angle of the light ray received by each of the first surfaces 1021 may be a Brewster's angle. In order to ensure transmittance of the first surface 1021, a high-transmittance film may be plated on the first surface 1021, which may further reduce the loss of light and at the same time reduce the occurrence of stray light. The incident angle of light ray emitted from the first surface 1021 having the emitting portion 1025 to the detector needs to be a non-Brewster's angle, i.e., θ_{B}+δ, δ≠0. After the exit light rays are emitted from the first surface 1021, they can enter a detector. By analyzing the exit light rays, the physicochemical properties of the sample to be measured can be obtained. Preferably, the first surface 1021 may be a Brewster's surface, that is, the incident angle of the light ray incident on the first surface 1021 is a Brewster's angle or a near Brewster's angle. When the incident angle is a near Brewster's angle, δ is close to 0.

The second surface 1023 is used for receiving light rays from the third surfaces 1022 of the present reflecting prism and refracting and emitting it to the first surface 1021 of other optical elements. Except for the second surface 1023 having the receiving portion 1024, in all the reflecting prisms 102, the angle of the light ray received by each of the second surfaces 1023 after being refracted may be a Brewster's angle. In order to ensure transmittance of the second surface 1023, a high-transmittance film may be plated on the second surface 1023, which may further reduce the loss of light and at the same time reduce the occurrence of stray light. The incident angle of the light ray received by the second surface 1023 having the receiving portion 1024 from the light source needs to be a non-Brewster's angle, i.e., θ_{B}+δ, δ≠0. The optical path of the light ray reflected from the second surface 1023 coincides with the optical path of the light ray refracted by the second face 1023. Preferably, the second surface 1023 may be a Brewster's surface, that is, the incident angle of the light ray incident on the second surface 1023 is a Brewster's angle or a near Brewster's angle. When the incident angle is a near Brewster's angle, δ is close to 0.

It should be noted that the second surface 1023 having the receiving portion 1024 and the first surface 1021 having the emitting portion 1025 may be different surfaces of different reflecting prisms, or may be different surfaces of the same reflecting prism. The present application is not limited thereto. Of course, in order to reduce the complexity of calibrating during use, the second surface 1023 having the receiving portion 1024 and the first surface 1021 having the emitting portion 1025 may be different surfaces of the same reflecting prism 102, as a preferred embodiment.

In the present embodiment, the third surface 1022 is used for receiving light rays from the first surface 1021 and totally reflecting the light rays to the second surface 1023. In order to reduce the loss of light during reflection, the third surface 1022 may be a total internal reflection surface. Preferably, the third surface 1022 can be plated with an internal reflection film to minimize the loss of light during propagation.

Taking the optical resonant cavity 100 shown in FIG. 13 as an example, in the reflecting prism 102, the third surface 1022 may be far away from the measurement region, that is, away from the sample to be measured; and the second surface 1023, the first surface 1021, and the surfaces not involved in the optical action can be in direct contact with the sample to be measured. With this arrangement, the third surface 1022 is not affected by the sample to be measured and impurities in the sample to be measured. Thus, the environmental adaptability of the optical resonant cavity 100 provided by the present embodiment can be greatly improved.

Continuing to refer to FIG. 13, in a preferred embodiment of the present application, in the optical resonant cavity 100, the optical element may include a first reflecting prism P, a second reflecting prism M, and a third reflecting prism N. After passing through the first reflecting prism P, the second reflecting prism M and the third reflecting prism N, light rays may form a closed optical path 101. Where, on the first reflecting prism P, the second surface 1023 has the receiving portion 1024 to receive light rays from a light source, and the first surface 1021 has the emitting portion 1025 to emit light rays to the detector.

The second surface 1023 of the first reflecting prism P is connected with the first surface 1021 of the second reflecting prism M through a first optical path L1, that is, light rays are emitted from the second surface 1023 of the first reflecting prism P and then reach the first surface 1021 of the second reflecting prism M along the first optical path L1. The second surface 1023 of the third reflecting prism N is connected with the second surface 1023 of the first reflecting prism P through a second optical path L2, that is, light rays are emitted from the second surface 1023 of the third reflecting prism N and then reach the second surface 1023 of the first reflecting prism P along the second optical path L2. The second surface 1023 of the second reflecting prism M is connected with the first surface 1021 of the third reflecting prism N through a third optical path L3, that is, light rays are emitted from the second surface 1023 of the second reflecting prism M and then reach the first surface 1021 of the third reflecting prism N along the third optical path L3.

In the present embodiment, an included angle between the first optical path L1 and the second optical path L2, an included angle between the second optical path L2 and the third optical path L3, and an included angle between the third optical path L3 and the first optical path L1 are all greater than

$$2 ( {asin}^{- 1} ( 1 / n ) + {asin}^{- 1} ( \frac{1}{n} ( sin ( {θ}_{B} ) ) ) - {θ}_{B} ) ,$$

wherein θ_{B} is a Brewster's angle. Preferably, in each of the reflecting prisms, an included angle between the third surface 1022 and the second surface 1023 is equal to an included angle between the third surface 1022 and the first surface 1021, and is equal to the sum of 0.5 time of an included angle between the first optical path L1 and the second optical path L2 and θ_{B}.

The length of the shortest side of the first surface 1021 and the second surface 1023 of the first reflecting prism P depends on the spot size. For example, the length of the side ab is at least larger than the size of an incident spot incident on the side ab. In particular, it should be noted that when the side ad in the first reflecting prism P is not involved in the optical action, but considering issues such as stray light reflected by the side ab, the angle of the surface where the side ad is located may be set to be a Brewster's angle for reducing stray light.

The lengths of the first optical path L1, the second optical path L2, and the third optical path L3 may be adjusted by translating the reflecting prism 102 as required, as long as the relative positional relationship of the reflecting prisms 102 satisfies the above Equations. For example, in a case where the size of the optical resonant cavity 100 is not emphasized, the lengths of the first optical path L1, the second optical path L2, and the third optical path L3 may be set to, for example, 10 cm to 100 cm. When the size of the measurement region is required, especially when it is required to be as small as possible, the lengths of the first optical path L1, the second optical path L2, and the third optical path L3 may be set to be, for example, on the order of millimeters, or even smaller.

In a specific embodiment, a triangle formed by the extended lines of the first optical path L1, the second optical path L2 and the third optical path L3 may be an equilateral triangle, the refractive index of the material of the reflecting prisms 102 is n≈1.52, and the shapes of the first reflecting prism P, the second reflecting prism M, and the third reflecting prism N may be completely identical. Considering a deviation that may occur in the actual design and processing, ∠cba=∠dcb≈6.66°, that is, the included angle between the third surface 1022 and the second surface 1023 is approximately 86.66 degrees.

In a feasible embodiment, a triangle formed by the extension lines of the first optical path L1, the second optical path L2, and the third optical path L3 may be an isosceles triangle and the first optical path L1 and the second optical path L2 are the legs of the isosceles triangle, and the refractive index of the material of the reflecting prism 102 is n≈1.52. Considering a deviation that may occur in the actual design and processing, in the first reflecting prism P, ∠cba=∠dcb≈79.98°, that is, the included angle between the third surface 1022 and the second surface 1023 is approximately 79.98 degrees. In the second reflecting prism M and the third reflecting prism N, the included angle between the third surface 1022 and the second surface 1023 is approximately equal to 90 degrees. Of course, the shapes of the second reflecting prism M and the third reflecting prism N may be identical. In this embodiment, the second reflecting prism M and the third reflecting prism N may each be a reflecting prism with a rectangular cross section, which is very convenient for design and processing and effectively enhances the degree of design freedom for the reflecting prism 102.

In another feasible embodiment, a triangle formed by the extension lines of the first optical path L1, the second optical path L2, and the third optical path L3 may be an isosceles triangle and the first optical path L1 and the second optical path L2 are the legs of the isosceles triangle, and the refractive index of the material of the reflecting prism 102 is n≈1.52. Considering a deviation that may occur in the actual design and processing, in the first reflecting prism P, ∠cba=∠dcb≈90°, that is, the included angle between the third surface 1022 and the second surface 1023 is approximately 90 degrees. In the second reflecting prism M and the third reflecting prism N, the included angle between the third surface 1022 and the second surface 1023 is approximately equal to 84.98 degrees. Of course, the shapes of the second reflecting prism M and the third reflecting prism N may be identical. In this embodiment, the first reflecting prism P may be a reflecting prism with a rectangular cross section, which is very convenient for design and processing and effectively enhances the degree of design freedom for the reflecting prism 102.

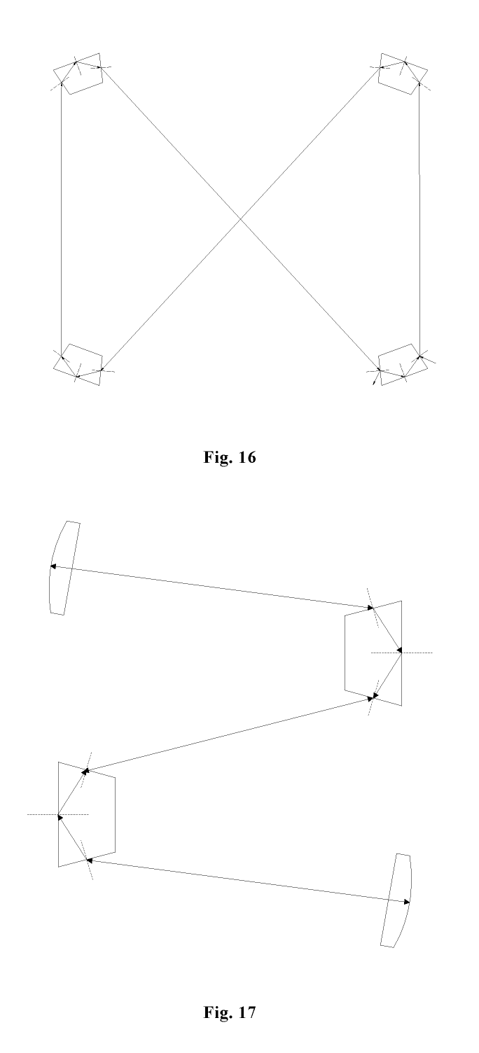

Referring to FIG. 15, FIG. 16, and FIG. 17, in a specific embodiment, the optical element may include four reflecting prisms, and all of the reflecting prisms may form the closed optical path. Specifically, the four reflecting prisms may form a “ [symbol] ”-shaped closed optical path as shown in FIG. 15 or a “Z”-shaped loop as shown in FIG. 17. In addition, the four reflecting prisms may also form an “8”-shaped closed optical path as shown in FIG. 16.

It should be noted that the shape and number of the reflecting prisms 102 are not limited to the above-mentioned exemplary embodiments. The three reflecting prisms may also form a “V”-shaped closed optical path as shown in FIG. 14. Therefore, other changes or modifications can be made by those skilled in the art in the light of the gist of the present application, but they should be covered by the protection scope of the present application as long as functions and effects thereof are the same as or similar to those of the present application.

It should also be noted that the optical element may only include one reflecting prisms 102. At this time, the reflecting prism 102 as a whole may have a notched ring shape. The notch of the reflecting prism 102 may be the measurement region, and two circular surfaces at the notch are the first surface 1021 and the second surface 1023; the entire side surface of the reflecting prism 102 is the third surface 1022 to ensure that in the closed optical path, light rays are incident on one side of the first surface 1021 and the second surface 1023 and into the reflecting prism 102 and are emitted from one of the first surface 1021 and the second surface 1023 after undergoing multiple reflections on the third surface 1022.

In the present embodiment, the quality factor of the optical resonant cavity 100 formed using the optical element may be represented by a Q value, which is defined as the stored energy divided by the energy loss per cycle. The higher the Q value is, the better the performance of the optical resonant cavity 100 for storing energy is, and the higher the sensitivity of the cavity optical resonant cavity is. According to the above description of the present application, in the optical element, the optical element can be rotated and/or translated, and then the reflection loss can be adjusted by rotating and/or translating the first reflecting prism P so that the Q value and coupling can be controlled. The reflection loss of each glass surface depends on Fresnel's law, and the loss value is approximately 10⁻⁴ δθ², δθ is an amount deviated from the Brewster's angle. At the same time, the distance between two adjacent optical elements can be regulated by translating the optical elements, thereby adjusting the lengths of the first optical path L1, the second optical path L2, and the third optical path L3.

In this embodiment, in order to keep the closed optical path 101 formed by the optical resonant cavity 100 stable and control the diffraction of light formed on the reflective surfaces, one surface of at least one of the reflecting prisms 102 in the optical element may be set to be a curved surface, that is, at least one of the first surface 1021, the second surface 1023 and the third surface 1022 is a curved surface. In order to further correct astigmatism caused by the oblique incidence of the beam, a condition for removing astigmatism needs to be satisfied between the curvature of the curved surface and the beam. The curvature of the curved surface can be solved by referring to knowledge of application optics and using optical design software.

Specifically, as shown in FIG. 11, the curved surface may be formed by optically processing at least one of the first surface 1021, the second surface 1023, and the third surface 1022. Optical processing may include physical processing such as polishing and polishing on at least one of the first surface 1021, the second surface 1023, and the third surface 1022. Further, as shown in FIG. 12, the curved surface may also be cemented by a lens 70 and at least one of the first surface 1021, the second surface 1023, and the third surface 1022 with an optical adhesive having a matching refractive index. The refractive index of the optical adhesive may be approximately equal to the refractive index of the curved surface. The refractive indices of the lens 70 and the reflecting prism 102 may be the same or different, and the present application is not limited thereto.

In addition, the curved surface may be formed by optical contact of the lens 70 with at least one of the first surface, the second surface, and the third surface. The optical contact means smoothing one surface of the lens 70 and at least one of the first surface, the second surface, and the third surface, pressing the two smoothed surfaces together, and then bonding the lens 70 with the reflecting prism 102 by attractive forces between molecules.

In order to further improve the coupling efficiency and reduce the loss of beam in the optical resonant cavity 100, a matching condition needs to be satisfied between the mode of the beam and the mode of the optical resonant cavity 100, that is, the waist spot radius and position of the light ray coupled to the optical resonant cavity 100 should completely coincide with the waist spot radius and position of the optical resonant cavity 100. The condition for mode matching can be calculated using the ABCD matrix described in the general principles above.

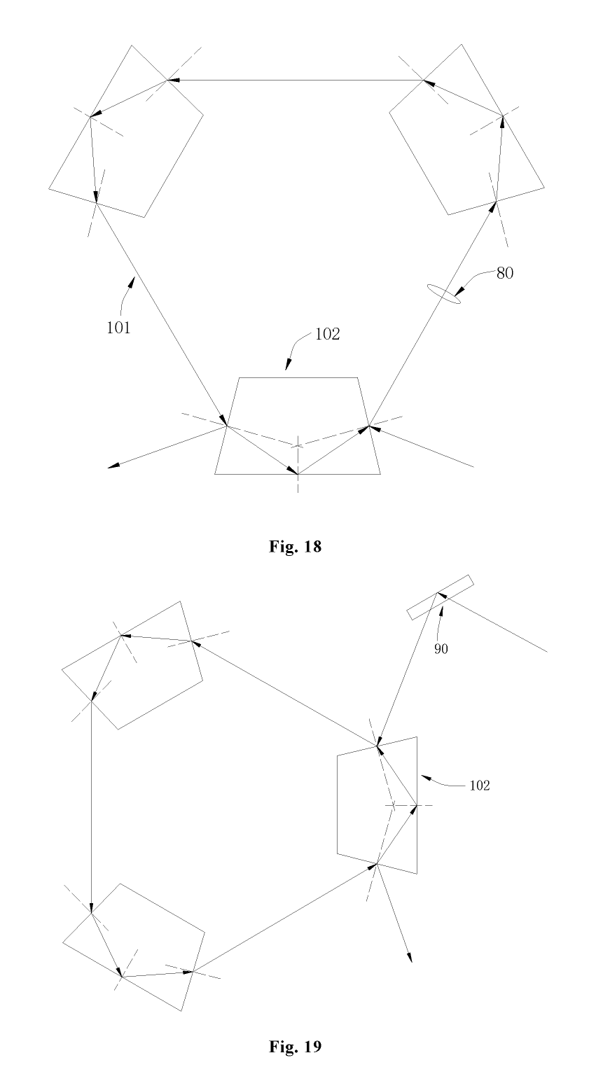

Referring to FIG. 18 and FIG. 19, in a preferred embodiment, the optical resonant cavity 100 may include a matching optical element that can match the mode of the light rays with the mode of the optical resonant cavity 100. Specifically, the matching optical element is located in the measurement region 103 and/or used to couple light radiation emitted by a light source (the light radiation is coupled into or out of the optical resonant cavity in the manner of evanescent waves, or is in contact with a sample measured in the manner of evanescent waves) to the receiving portion 1024. The matching optical element comprises at least one lens 80 and/or at least one reflector 90. The matching optical element has at least one non-planar surface, and the non-planar surface includes at least one of a spherical surface, a cylindrical surface, an ellipsoidal surface, a paraboloidal surface, and a free-form surface.

The lens 80 may be located on one or more of the first optical path L1, the second optical path L2, and the third optical path L3. The number of the lenses 80 may be one or more, and may be located anywhere on the optical path.

The reflector 90 couples the light radiation to the receiving portion 1024. The reflector 90 can match the mode of the light rays emitted by the light source with the mode of the optical resonant cavity 100. The reflector 90 can cause the light rays to be incident onto the receiving portion 1024 at a near Brewster angle. The reflector 90 may be disposed between the light source and the receiving portion 1024.

It should be noted that the foregoing several embodiments are merely exemplary embodiments for satisfying the matching condition between the mode of the light beam and the mode of the optical resonant cavity. Other changes or modifications can be made by those skilled in the art in the light of the gist of the present application, but they should be covered by the protection scope of the present application as long as functions and effects thereof are the same as or similar to those of the present application.

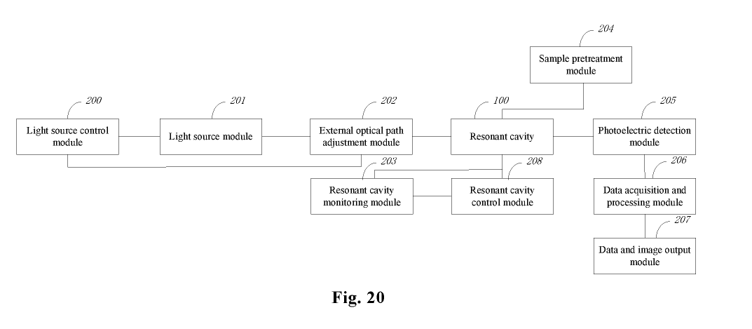

Referring to FIG. 20, an embodiment of the present application further provides a spectral measurement instrument, comprising the optical resonant cavity 100 described in the above embodiment.

The measurement method used in the present invention is an optical method, including but not limited to: absorption spectrum, Raman spectrum, scattering spectrum, fluorescence, photoacoustic spectrum, excitation spectrum, Fourier transform spectrum, optical frequency comb, and the like.

The spectral measurement instrument may include a cavity ring-down spectral measurement instrument and a cavity-enhanced spectral measurement instrument. The optical resonant cavity 100 may be preferably used in the cavity ring-down spectral measurement instrument and the cavity-enhanced spectral measurement instrument, and may also be applied to photoacoustic, Raman, scattering, excitation, fluorescence and other fields. The spectral measurement instrument may comprise a light source control module 200, a light source module 201, an external optical path adjustment module 202, the optical resonant cavity 100, an optical resonant cavity monitoring module 203, an optical resonant cavity control module 208, a sample pretreatment module 204, an photo-electric detection module 205, a data acquisition and processing module 206, and data and image output module 207. It should be particularly noted that the measurement modules shown in FIG. 17 may be appropriately increased or decreased according to actual measurement requirements. If the sample to be measured does not need to be pretreated, the sample pretreatment module 204 may be omitted.

The light source control module 200 is used for the functions of the light source module 201 such as controlling on or off, frequency modulation, current tuning and temperature tuning

The light source module 201 may have different forms according to different detection technologies and usage requirements, including, but not limited to, a laser light source, a broadband light source, a combination of different frequency laser light sources, a combination of a laser light source and a broadband light source, and the like.

The external optical path adjusting module 202 is used for changing the polarization property of light, the divergence angle of the light beam, the energy distribution of the light field, and the like, and feeding back a signal to the light source control module 200. The external optical path adjusting module 202 includes, but is not limited to, a polarizing device, an optical coupling device, a light cutting device, and the like.

The optical resonant cavity 100 is an optical delay system for increasing the propagation path of light rays, increasing the optical path length, and improving the system measurement sensitivity. The optical resonant cavity 100 includes, but is not limited to, a multiple-reflection cavity, an optical resonant cavity, and the like. The optical resonant cavity 100 includes the optical element as described above.

The optical resonant cavity monitoring module 203 is used for monitoring the operating state of the reflective cavity 101, fault alarm, and on-line real-time calibration of the equivalent absorption optical path of the optical resonant cavity 100, and providing a monitoring signal to the optical resonant cavity control module 208.

The optical cavity control module 208 is used for on-line correcting the relative position relationships of the optical devices in the optical cavity 100 in real time according to the monitoring signal provided by the optical cavity monitoring module 203. The optical cavity control module 208 includes, but is not limited to, at least one PZT or other mechanical structures or devices having a translation and rotation function or a combination thereof, to change the relative position relationships of the optical devices in the optical cavity 100.

The sample pretreatment module 204 is used for pretreating the sample to be measured. The pretreatment performed by the sample pretreatment module 204 includes, but is not limited to, heating the sample to be measured, filtering out water in the sample, filtering out other impurities in the sample that are not related to the measurement, filtering out dust, etc.

The photo-electric detection module 205 is used for receiving and detecting an optical signal output by the optical resonant cavity 100, converting the optical signal into an electrical signal, and performing filtering, amplification, analog-to-digital conversion, and other processing of the signal.

The data acquisition and processing module 206 collects converted photo-electrical digital signals and performs spectral signal processing such as averaging and concentration calculation.

The data and image output module 207 is used for outputting data and image information such as spectral lines, molecular spectral absorption intensity, and concentration values of the sample. It should be noted that the data and image output module 207 is configured to display information such as element concentration, and the form and structure thereof are not limited thereto.

The foregoing has shown and described the basic principles, main features, and advantages of the present invention. It should be understood by those skilled in the art that the present invention is not limited by the foregoing embodiments. The foregoing embodiments and description only describe the principles of the present invention. However, various changes and modifications of the present invention may be made without departing from the spirit and scope of the present invention, and shall fall within the scope of the invention as claimed. <0-{ }-} The protection scope of the invention is defined by the appended claims and their equivalents.

1. A reflecting prism for an optical resonant cavity, said optical resonant cavity having a sample measurement region, wherein said reflecting prism comprises a first surface for receiving light rays passing through said sample measurement region, a second surface for emitting light rays to said sample measurement region, and a third surface between said first surface and said second surface, said third surface for totally reflecting the light rays received from said first surface to said second surface.

2. The reflecting prism according to claim 1, wherein said first surface and said second surface are Brewster's surfaces, and said third surface is a total internal reflection surface.

3. The reflecting prism according to claim 1, wherein at least one surface of said reflecting prism is a curved surface.

4. An optical resonant cavity capable of receiving and emitting light rays and capable of transmitting the received light rays internally, wherein the optical resonant cavity comprises:
an optical element, said optical element comprising at least one reflecting prism according to claim 1; and
a sample measurement region capable of containing a sample to be measured.

5. The optical resonant cavity according to claim 4, wherein said optical element is capable of forming a closed optical path.

6. The optical resonant cavity according to claim 4, wherein the number of said optical elements is at least three.

7. The optical resonant cavity according to claim 6, wherein each of said optical elements is said reflecting prism.

8. The optical resonant cavity according to claim 7, wherein said reflecting prism comprises a first reflecting prism, a second reflecting prism and a third reflecting prism; a second surface of said first reflecting prism is connected with a first surface of said second reflecting prism through a first optical path, a second surface of said third reflecting prism is connected with a first surface of said first reflecting prism through a second optical path, and a second surface of said second reflecting prism is connected with a first surface of said third reflecting prism through a third optical path; an included angle between said first optical path and said second optical path, an included angle between said second optical path and said third optical path, and an included angle between said third optical paths and said first optical path are all greater than
$$2 ( {asin}^{- 1} ( 1 / n ) + {asin}^{- 1} ( \frac{1}{n} ( sin ( {θ}_{B} ) ) ) - {θ}_{B} ) ,$$
wherein θ_{B} is a Brewster's angle.

9. The optical resonant cavity according to claim 8, wherein in each of said reflecting prisms, an included angle between said third surface and said second surface is equal to an included angle between said third surface and said first surface, and is equal to 0.5 time of the sum of the included angle between said first optical path and said second optical path and θ_{B}.

10. The optical resonant cavity according to claim 4, further comprising: a matching optical element capable of matching an optical mode of a light source with an optical mode of said optical resonant cavity.

11. The optical resonant cavity according to claim 4, wherein at least one of said optical elements is capable of being rotated and/or translated.

12. A spectral measurement instrument, comprising: the optical resonant cavity according to claim 4.

13. The spectral measurement instrument according to claim 12, wherein said first surface and said second surface are Brewster's surfaces, and said third surface is a total internal reflection surface.

14. The spectral measurement instrument according to claim 12, wherein at least one surface of said reflecting prism is a curved surface.

15. The spectral measurement instrument according to claim 12, wherein said optical element is capable of forming a closed optical path.

16. The spectral measurement instrument according to claim 12, wherein the number of said optical elements is at least three.

17. The spectral measurement instrument according to claim 16, wherein each of said optical elements is said reflecting prism.

18. The spectral measurement instrument according to claim 12, further comprising: a matching optical element capable of matching an optical mode of a light source with an optical mode of said optical resonant cavity.

19. The optical resonant cavity according to claim 4, wherein said first surface and said second surface are Brewster's surfaces, and said third surface is a total internal reflection surface.

20. The optical resonant cavity according to claim 4, wherein at least one surface of said reflecting prism is a curved surface.
